(19) United States
(12) Patent Application Publication
(10) Pub. No.: US 2012/0056108 A1
(43) Pub. Date: Mar. 8, 2012

(54) SURFACE MODIFICATION METHOD OF FLUOROPOLYMERS BY ELECTRON BEAM IRRADIATION AND THE FABRICATION OF SUPERHYDROPHOBIC SURFACES USING THE SAME

(75) Inventors: Jae-Hak Choi, Daejeon (KR); Eun Je Lee, Daejeon (KR); Chan-Hee Jung, Gwangju (KR); In-Tae Hwang, Seoul (KR); Young-Chang Nho, Daejeon (KR); Sung Oh Cho, Daejeon (KR)

(73) Assignees: KOREA HYDRO AND NUCLEAR POWER CO., LTD., Seoul (KR); KOREA ATOMIC ENERGY RESEARCH INSTITUTE, Daejeon (KR)

(21) Appl. No.: 13/092,092

(22) Filed: Apr. 21, 2011

(30) Foreign Application Priority Data
Sep. 3, 2010 (KR) 10-2010-0086541

(51) Int. Cl. G21K 5/00

(52) U.S. Cl. 250/492.3

(57) ABSTRACT

A method for the surface modification of fluoropolymer films using electron beam irradiation to generate superhydrophobic surfaces is provided. This surface modification method can cause simultaneously both a physical modification roughening the fluoropolymer surfaces and a chemical modification changing the surface composition of the fluoropolymers, and therefore fabricating the superhydrophobicity on a fluoropolymer surface by controlling the dose of electron beam irradiation. Therefore, this method for the surface modification of fluoropolymers by electron beam irradiation can be used in the generation of superhydrophobic surfaces required in various industries such as paint, glue, fine chemistry, electrical and electronics, cars, and display manufacturing.

### CROSS REFERENCE TO RELATED APPLICATIONS

This application claims priority from Korean Patent Application No. 10-2010-0086541, filed on Sep. 3, 2010, in the Korean Intellectual Property Office, the disclosure of which is incorporated herein by reference in its entirety.

### BACKGROUND OF THE INVENTION

1. Field of the Invention

The present invention relates to a method for fabricating superhydrophobic surfaces on fluoropolymers by electron beam irradiation.

2. Description of the Related Art

Hydrophobicity represents the relationship between water and the surface of a material. In theory, hydrophobicity means chemical characteristic of no affinity to water. As the hydrophobicity increases, so does the contact angle between water and the surface of a material. For example, if a contact angle exceeds 150°, a surface exhibits superhydrophobicity and water forms a nearly round shape on the material surface.

Generally, materials with hydrophobicity can easily be observed in nature. Leaves of Taro and Lotus are representative materials. Wenzel's and Cassie's models have revealed that superhydrophobicity depends on the surface roughness and chemical nature of the surface.

Various physical and chemical methods have been utilized to make the surface of materials hydrophobic or superhydrophobic. The physical method is used to form roughness on the surface of a material and the chemical method is used to perform fluorine coating on the surface of a material, such as a frying pan. In particular, after such modifications, fluoropolymers tend to become more hydrophobic.

The wettability of a material is determined by the surface energy and surface roughness of the material. Therefore, to control the surface wettability, a technology is required to control the surface energy and surface roughness. In particular, to generate superhydrophobicity which has a high water-repellency, a highly-roughened surface with a low surface energy is required.

Various methods have been developed to meet the above-mentioned demands. These methods can be categorized into two strategies: the first strategy is based on roughening the surface of a non-specific material followed by coating with a low surface energy material, and the second strategy is based on roughening the surface of a low surface energy material. A fluoropolymer, a representative material with a low surface energy, has been widely used in the development of the second strategy-based techniques to form superhydrophobic surfaces. The common methods for the generation of a superhydrophobic surface include a template-based method for the fabrication of a highly-roughened surface (W. Hou et al. J. Colloid Interf. Sci. 333, 400 (2009)), an extension method (J. Zhang et al. Macromol. Rapid Commun. 25, 1105 (2004)), a pulsed laser deposition method (H. Y. Kwong et al. Appl. Surf. Sci. 253, 8841 (2007)), an electrospraying method (Burkarter et al. J. Phys. D: Appl. Phys. 40, 7778 (2007)), and a radiation method.

Among the above-mentioned methods, a radiation method is simple and capable of large-scale production, which is quite suitable for practical industries. Radiation-based methods have been developed and reported, including Argon (Ar⁺) ion implantation (Y. Inoue et al. Colloids Surf. B: Biointerf. 19, 257 (2000)), Xenon (Xe⁺) ion implantation (Y. Chen et al. Appl. Surf. Sci. 254, 464 (2007)), O₂ RF plasma treatment (N. Vandencasteele et al. Plasma Process. Polym. 5, 661 (2008)), and synchrotron radiation irradiation (K. Kanda et al. Jpn. J. Appl. Phys. 42, 3983 (2003)).

U.S. Pat. No. 4,869,922 discloses a method of coating poly-fluorocarbon on a surface of a material by using vacuum plasma. To be specific, under a pressure of 1 torr, a mixture gas of hydrogen gas and monomer C—F gas is injected into the discharge area, 27.12 Mhz of radio frequency voltage is applied at 4080 W for 5 to 20 minutes, and the surface of aluminum specimen is then coated with poly-fluorocarbons to give the surface hydrophobicity. However, the above-mentioned invention is a simple chemical method based on a simple coating of the material surfaces with fluoromaterials, and thus it has difficulty achieving superhydrophobicity and is also inappropriate for large-scale processing.

Korean Patent Publication No. 2010-0011213 relates to a method of manufacturing superhydrophobic material and the superhydrophobic material manufactured by the method, and more particularly, to an electrochemical method of manufacturing materials with superhydrophobic surfaces. More specifically, a metal layer is formed on the surface of materials by a electrochemical method, a nano-structured metal oxide layer was generated by anodizing the formed metal layer, and finally, the hydrophobic monolayer of organic molecules was formed on the formed nano-structured metal oxide layer to obtain a superhydrophoic surface. However, Korean Patent Publication No. 2010-0011213 requires multiple fabrication steps and high production costs caused by using expensive metals to generate the highly-roughened structure on the surface, and therefore, it is difficult to be commercialized.

Accordingly, while studying the fabrication of a superhydrophobic surface of a fluoropolymeric material, the present inventors invented the simple fabrication method for a superhydrophoic surface using an electron beam, which offers a simple one-step process. Also, electron beams have deeper penetration depth and can more effectively break molecular bonds in comparison to the other radiations reported in the previous literatures. This invention offers a one-step physiochemical modification of a large-area surface in comparison to the previous methods disclosed above.

### SUMMARY OF THE INVENTION

The present inventive technical concept provides a simple method for the fabrication of large-area superhydrophobic surfaces of fluoropolymers.

To achieve the above-mentioned purpose, a fabrication method for a superhydrophobic fluoropolymer surface using a one-step electron beam irradiation process is provided.

Since this surface modification method of electron beam irradiation can fabricate superhydrophbic surfaces on fluoropolymers through a one-step irradiation process, which can be controlled by adjusting the dose of the electron beams, this method can be very useful in the generation of surface properties such as water repellency, antifouling, non-stickiness, and low-surface energy in the various industries such as paint, glue, fine chemistry, electrical and electronics, cars, and display manufacturing. Furthermore, this method is applicable to out-of-state research fields including next-generation batteries, microfluidics, electrowetting displays, and so on.

### BRIEF DESCRIPTION OF THE DRAWINGS

The above-mentioned and/or other aspects of what is described herein will be more apparent by describing certain exemplary embodiments with reference to the accompanying drawings, in which:

FIG. 1 illustrates the fabrication process of fluoropolymer with a superhydrophobic surface according to a particular embodiment;

FIG. 2 shows scanning electron microscope (SEM) images for the changes at the surface morphologies of PTFE films before and after electron beam irradiation according to a particular embodiment;

FIG. 3 illustrates X-ray photoelectron spectroscopic spectra for the chemical changes in the surface of PTFE films before and after electron beam irradiation a particular embodiment; and

FIG. 4 shows photographs of the changes in water contact angle of PTFE films before and after electron beam irradiation according to a particular embodiment.

### DETAILED DESCRIPTION OF EXEMPLARY EMBODIMENTS

The present inventive concept will be explained in detail below.

In one embodiment, a method for modifying the surfaces of fluoropolymers using electron beam irradiation to generate a superhydrophobic surface is provided.

To be concrete, the electron beam irradiation induces simultaneously both a physical modification roughening the fluoropolymer surfaces and a chemical modification changing the surface composition of the fluoropolymers, therefore, resulting in superhydrophobic fluoropolymer surfaces.

In the method for modifying the surface of fluoropolymers by electron beam irradiation to generate a superhydrophobic surface according to an embodiment, the fluoropolymer materials may be a film form of polytetra fluoroethylene (PTFE), fluorinated ethylene propylene (FEP), poly(tetrafluoethylene-co-perfluoroalkyl vinyl ether (PFA), poly(ethylene-co-tetrafluorethylene (ETFE), or poly(vinylidene fluoride (PVDF), or the fluoropolymer materials may desirably be a polytetra fluoroethylene film.

In one embodiment, a thickness of 1 to 500 μm is desirable for the fluoropolymer. If the thickness of the film is less than 1 μm, the energy of electron beams passes through the fluoropolymer film before the energy is fully transferred to fluoropolymer film, and if the thickness of the film exceeds 500 μm, a high energy electron beam with hundreds of keV or more is required, thus increasing production costs.

In one embodiment, the energy of the electron beam ranging from 10 to 500 keV is desirable. If the energy of the electron beam is less than 10 keV, the penetration depth is too shallow to fabricate the high roughness structure of superhydrophobicity, and if the depth exceeds 500 keV, the electron beam is so deeply penetrated that most reactions induced by electron beam irradiation occur inside the film rather than on the surface, which is inappropriate for surface modification.

In one embodiment, a current density of 1 to 20 μA/cm² for the electron beam desirable. If the current density is less than 1 pA/cm², the electron beam-induced reaction of the electron beam per unit period occurs too weak to obtain the desirable surface modification effect, and if the current density exceeds 20 pA/cm², the heat is generated on the sample during the irradiation, therefore leading to the occurrence of an undesirable thermal reaction.

In one embodiment, a dose of between 1×10¹⁶ electrons/cm² and 1×10¹⁹ electrons/cm² for the electron beam irradiation is desirable. If the dose is less than 1×10⁶ electrons/cm², the extent of the surface modification is too weak to achieve superhydrophobicity, and if the dose exceeds 1×10⁹ electrons/cm², the extent of the surface modification is too severe to achieve superhydrophobicity.

In one embodiment, as the dose of the electron beam irradiation increases, the surface roughness increases gradually and the atomic content of the fluorine on the surface decreases, while the relative atomic contents of oxygen and carbon increase gradually. The above-mentioned result reveals that the surface of a fluoropolymer film is physically and chemically modified by electron beam irradiation. In particular, it is found that a superhydrophobic surface with a water contact angle over 150° is formed at electron beam irradiation doses between 4×10¹′ and 1×10¹⁸ electron/cm².

Therefore, by controlling the dose of electron beam irradiation, the surface of a fluoropolymer can be modified to become superhydrophobic. Moreover, the surface of polymers can be effectively modified to meet the needs of the user.

The present inventive technical concept will be explained in greater detail below based on the examples that are not to be construed as the limits of the present inventive concept.

### Example 1

### Surface Modification of a PTFE Film by Electron Beam Irradiation

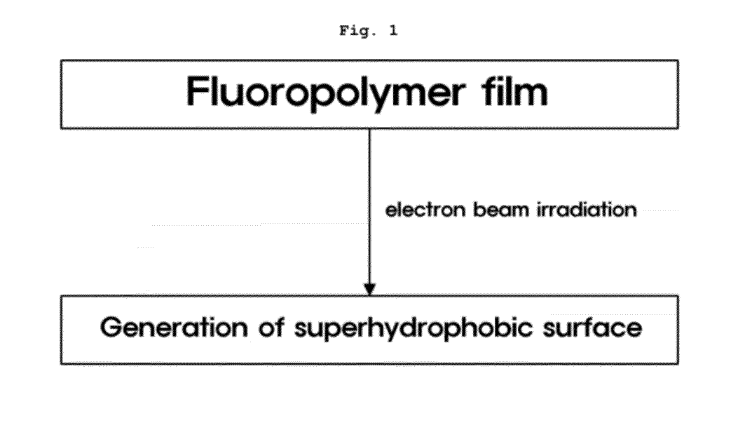

As illustrated in FIG. 1, a 100-μm thick PTFE (Polytetrafluoroethylene, Ashai Glass) film was modified by an electron beam irradiation and a superhydrophobic surface was generated on the irradiated PTFE by controlling the conditions of the electron beam irradiation. To be specific, a PTFE film was put in a self-made electron beam irradiation device, and the device was then vacuumized to below 2×10⁻⁵ torr. The electron beam irradiation was carried out with 30 kV of acceleration voltage, 30 keV of electron beam energy, and 8 μA/cm² of current density to modify the surface of PTFE film. The irradiation time was controlled such that the doses of electron beam irradiation were (I) 0, (II) 5×10¹⁶, (III) 2.5×10¹⁷, (IV) 4×10¹⁷, (V) 6×10¹⁷, and (VI) 1×10¹⁸ electrons/cm².

### Example 2

### Surface Modification of FEP Film by Electron Beam Irradiation

Except for the use of 100-μm thick FEP (Fluorinated ethylene propylene, Ashai Glass) film, the same process as explained in Example 1 was performed to modify the surface of a FEP film.

### Example 3

### Surface Fabrication of PFA Film by Electron Beam Irradiation

Except for the use of 100-μm thick PFA (Poly(tetrafluoroethylene-co-perfluoroalkyl vinyl ether), Ashai Glass) film, the same process as explained in Example 1 was performed to modify the surface of a PFA film.

Table 1 shows the lists of materials used in Examples 1 through 3 and the conditions used in the electron beam irradiation.

TABLE 1

| | Polymer film | Energy of | Current | Dose of electron |
|---|---|---|---|---|
| | (100 μm in | electron beam | density | beam Irradiation |
| | thickness) | (keV) | (μA/cm²) | (electrons/cm²) |
| Example 1 | PTFE | 30 | 8 | 0~1 × 10¹⁸ |
| Example 2 | FEP | 30 | 8 | 0~1 × 10¹⁸ |
| Example 3 | PFA | 30 | 8 | 0~1 × 10¹⁸ |

### Experimental Example 1

### Evaluation of the Structural Surface Modifications of Polymer Films by Electron Beam Irradiation

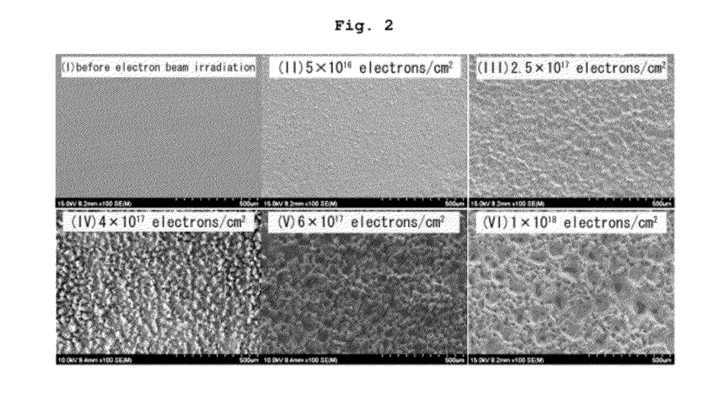

To investigate the structural surface modification of PTFE films irradiated at the doses of (I)˜(VI) of Example 1, a scanning electron microscope (SEM, S-4800, Hitachi) was used, and the SEM images of FIG. 2 were obtained.

FIG. 2 provides SEM images for the structural changes in the surfaces of polymer films.

As shown FIG. 2, the surface roughness increases with an increasing dose of electron beam irradiation. This result confirms the occurrence of the structural modification on the irradiated surfaces.

### Experimental Example 2

### Evaluation of the Chemical Surface Modifications of Polymer Films by Electron Beam Irradiation

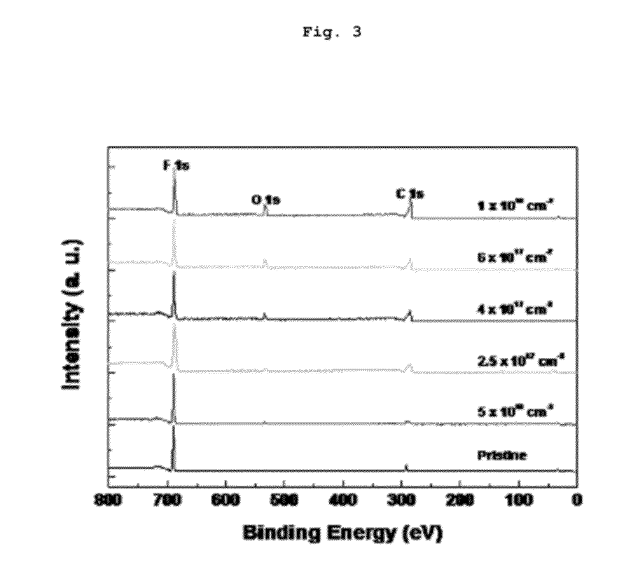

To investigate the chemical modification of the surfaces of PTFE films PTFE films irradiated at the doses of the (I)˜(VI) of Example 1, an X-ray photoelectron spectrometer (XPS, Sigma Probe, Thermo VG Scientific) was used, and the results are shown in Table 2 and FIG. 3.

TABLE 2
Changes in the surface chemical composition
of PTFE films by electron beam irradiation

| Dose of electron | | | |
|---|---|---|---|
| beam Irradiation | | | |
| (electrons/cm²) | F(%) | C(%) | O(%) |
| (I) 0 | 65.58 | 34.42 | — |
| (II) 5 × 10¹⁶ | 52.41 | 45.07 | 2.52 |
| (III) 2.5 × 10¹⁷ | 50.78 | 45.62 | 3.60 |
| (IV) 4 × 10¹⁷ | 47.65 | 47.81 | 4.54 |
| (V) 6 × 10¹⁷ | 34.56 | 57.78 | 7.66 |
| (VI)1 × 10¹⁸ | 24.46 | 65.56 | 9.98 |

FIG. 3 illustrates an X-ray photoelectron spectroscopic spectrum for the chemical changes in the surface of PTFE films according to a particular embodiment.

As illustrated in FIG. 3, as the dose of electron beam irradiation was increased, the atomic content of fluorine (F) decreased and the atomic contents of carbon (C) and oxygen (O) contents increased, which confirms the occurrence of the chemical modification of the irradiated surfaces.

### Experimental Example 3

### Evaluation of the Formation of Superhydrophobic Surfaces

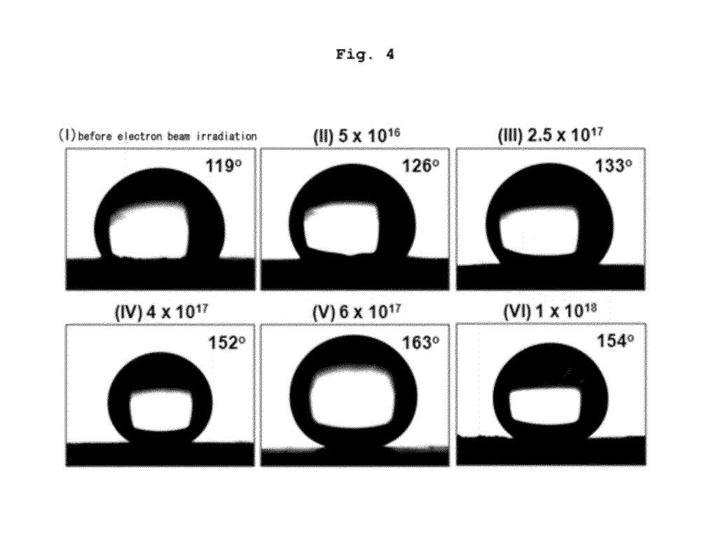

To measure the superhydrophobicity of surfaces of PTFE films irradiated at the doses of the (I)˜(VI) from Example 1, the water contact angle measurement was performed using a contact angle analyzer (Phoenix 300, Surface Electro Optics Company), and the results are listed in Table 3 and shown in FIG. 4.

TABLE 3
Changes in water contact angle on the surface of PTFE
films with an dose of electron beam irradiation

| Dose of electron beam | |
|---|---|
| Irradiation (electrons/cm²) | Contact angle |
| (I) 0 | 119° |
| (II) 5 × 10¹⁶ | 126° |
| (III) 2.5 × 10¹⁷ | 133° |
| (IV) 4 × 10¹⁷ | 152° |
| (V) 6 × 10¹⁷ | 163° |
| (VI) 1 × 10¹⁸ | 154° |

FIG. 4 shows photographs for the changes in water contact angle on a surface of PTFE film onto which an electron beam is irradiated, according to an particular embodiment.

As shown in FIG. 4, the contact angle of the PTFE film surface before electron beam irradiation was 119°, which is generally hydrophobic. However, after irradiation, the contact angle increased with an increasing dose of up to (V), over which it decreased. At the doses of electron beam irradiation ranging from (IV) to (VI), the contact angles exceeded 150°, thereby indicating superhydrophobicity. The highest contact angle was obtained at the dose of (V). Therefore, the optimal dose of electron beam irradiation for the fabrication of a superhydrophobic surface is 6×10¹⁷ electrons/cm² of (V).

The foregoing exemplary embodiments and advantages are merely exemplary, and are not to be construed as limits of the present inventive concept. The present instructions can be readily applied to other types of apparatuses. Also, the descriptions of the exemplary embodiments of the present invention are intended to be illustrative, and are not meant to limit the scope of the claims, and many alternatives, modifications, and variations will be apparent to those skilled in the art.

What is claimed is:

1. A method for modifying the surfaces of fluoropolymers by electron beam irradiation to generate a superhydrophobic surface.

2. The method of claim 1, wherein the fluoropolymers are selected from a group consisting of polytetra fluoroethylene (PTFE), fluorinated ethylene propylene (FEP), poly(tetrafluoethylene-co-perfluoroalkyl vinyl ether (PFA), poly(ethylene-co-tetrafluoroethylene (ETFE), and poly(vinylidene fluoride (PVDF) in a form of film.

3. The method of claim 2, wherein the fluoropolymer film is polytetra fluoroethylene (PTFE) film.

4. The method of claim 2, wherein the thickness of the fluoropolymer film is 1˜500 μm.

5. The method of claim 1, wherein the energy of the electron beam is 10˜500 keV.

6. The method of claim 1, wherein the current density of the electron beam is 1˜200 μA/cm².

7. the method of claim 1, wherein the dose of the electron beam irradiation is between 1×10¹⁶ electrons/cm² and 1×10¹⁹ electrons/cm².
